(19) United States
(12) Patent Application Publication
(10) Pub. No.: US 2017/0143588 A1
(43) Pub. Date: May 25, 2017

(54) AUTOMATIC MEDICINE PACKING MACHINE

(71) Applicant: JVM CO., LTD., Daegu (KR)

(72) Inventor: Jun Ho KIM, Daegu (KR)

(21) Appl. No.: 15/356,129

(22) Filed: Nov. 18, 2016

(30) Foreign Application Priority Data
Nov. 25, 2015 (KR) 10-2015-0165596

(51) Int. Cl. A61J 7/00; B65B 57/00; G07F 11/10; B65B 61/28

(52) U.S. Cl. CPC A61J 7/0084; B65B 61/28; B65B 57/00; G07F 11/10

(57) ABSTRACT

An automatic medicine packing machine is provided. The automatic medicine packing machine includes a main body provided with an installation space formed therein and a hopper formed in the lower portion thereof to allow medicines to be dropped into the hopper, cassette supports installed in the installation space and having mounting positions of cassettes to accommodates the medicines, display units configured to receive a driving signal transmitted from the outside and then to display the cassette mounting positions to the outside, and a controller configured to predetermine information on selected medicines and reference mounting positions of the selected medicines and to, if medicine information is input from the outside, display positions of the cassettes to be mounted based on the input medicine information to the outside through the display units.

### BACKGROUND OF THE INVENTION

Field of the Invention

The present invention relates to an automatic medicine packing machine and, more particularly, to an automatic medicine packing machine which recommends optimal discharge positions of medicines according to characteristics of the medicines and installs cassettes accommodating the medicines at the recommended optimal discharge positions so as to prevent the medicines dropping into a hopper from bouncing and thus being separated to the outside, and prevents mixing or breakage of the medicines so as to optimize a prescription filling speed.

Description of the Related Art

In general, an automatic medicine packing machine is used to automatically pack medicines prescribed by a doctor or a pharmacist based on a prescription.

A conventional automatic medicine packing machine includes a main body in which a plurality of cassette supports is installed, a hopper to gather medicines discharged from the main body, a medicine packing unit to pack the medicines transmitted from the hopper and then to discharge the packed medicines to the outside, and cassettes installed on the cassette supports.

Further, the cassette includes a body which accommodates medicine and is provided with a medicine discharge path formed at the lower part thereof, and a driving unit installed on the body to discharge a dose of the medicine through rotation of a rotary body.

However, in the conventional automatic medicine packing machine, medicine is disposed at a position (at a height) regardless of characteristics of the medicine and, thus, if a cassette accommodating the medicine is not located at an optimal position, hard medicine may bounce from a middle hopper and thus be separated to the outside and, if the strength of the medicine is low, the medicine may be mixed with other medicines or be damaged.

As prior art documents related to the present invention, Korean Patent Laid-open Publication No. 10-1991-0004426 (Publication Date: Mar. 28, 1991) discloses a medicine packing machine.

### SUMMARY OF THE INVENTION

Therefore, the present invention has been made in view of the above problems, and it is an object of the present invention to provide an automatic medicine packing machine which recommends optimal discharge positions of medicines according to characteristics of the medicines and installs cassettes accommodating the medicines at the recommended optimal discharge positions so as to prevent the medicines dropping into a hopper from bouncing and thus being separated to the outside, and prevents mixing or breakage of the medicines so as to optimize a prescription filling speed.

In accordance with the present invention, the above and other objects can be accomplished by the provision of an automatic medicine packing machine including a main body provided with an installation space formed therein and a hopper formed in the lower portion thereof to allow medicines to be dropped into the hopper, cassette supports installed in the installation space and having mounting positions of cassettes to accommodates the medicines, display units configured to receive a driving signal transmitted from the outside and then to display the cassette mounting positions to the outside, and a controller configured to predetermine information on selected medicines and reference mounting positions of the selected medicines and to, if medicine information is input from the outside, display positions of the cassettes to be mounted based on the input medicine information to the outside through the display units.

The display units may be respectively installed at the cassette mounting positions and output light or sound to the outside so as to indicate the cassette mounting positions to the outside.

A communication module may be installed in the cassette, and the controller may transmit an operating signal to the communication module so as to operate the cassette.

Order of priority of the reference mounting positions may be predetermined according to the information on the selected medicines, and the controller may detect the reference mounting positions having no cassettes installed there at and then indicate the reference mounting position having the highest priority to the outside.

A lower case provided with an outlet formed on the front surface thereof may be installed under the main body, and a medicine packing unit installed under the hopper and serving to pack the medicines discharged from the hopper within medicine packets and to discharge the medicine packets to the outside through the outlet may be provided in the lower case.

The controller may inspect medicine packets packing the medicines, predetermine information on error medicines having high error occurrence frequency, detect the reference mounting positions of the cassettes according to the predetermined error medicines, and indicate the reference mounting positions of the cassettes to be mounted based on the input medicine information to the outside through the display units.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view illustrating an automatic medicine packing machine in accordance with the present invention; and

FIG. 2 is a block diagram schematically illustrating the automatic medicine packing machine in accordance with the present invention.

### DETAILED DESCRIPTION OF THE INVENTION

Reference will now be made in detail to the preferred embodiments of the present invention, examples of which are illustrated in the accompanying drawings.

Advantages and features of the present invention and a method of achieving the same will be more clearly understood from the following detailed embodiments taken in conjunction with the accompanying drawings.

However, the present invention is not limited by the embodiments which will be described hereinafter but may be variously modified. The embodiments are provided to those skilled in the art only to completely understand the scope and spirit of the present invention, and the present invention is defined only by the claims of the present invention.

In addition, in the following description of the present invention, a detailed description of known functions and configurations incorporated herein will be omitted when it may make the subject matter of the present invention rather unclear.

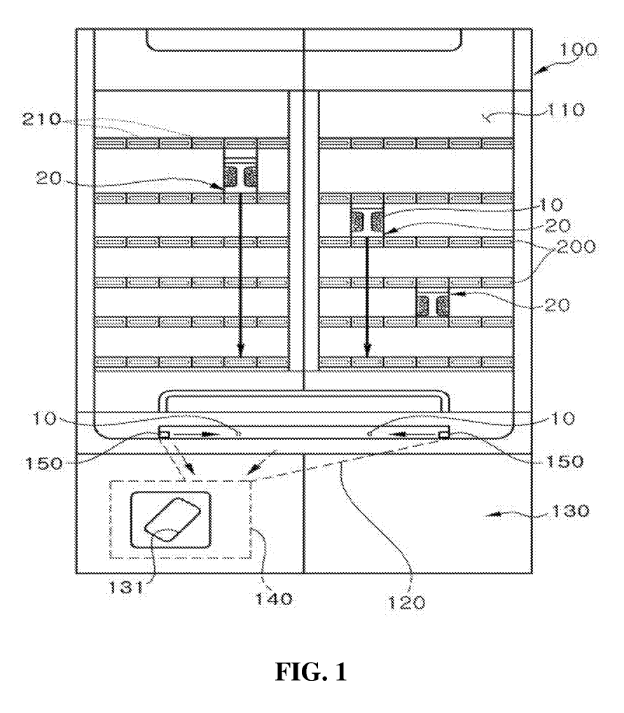

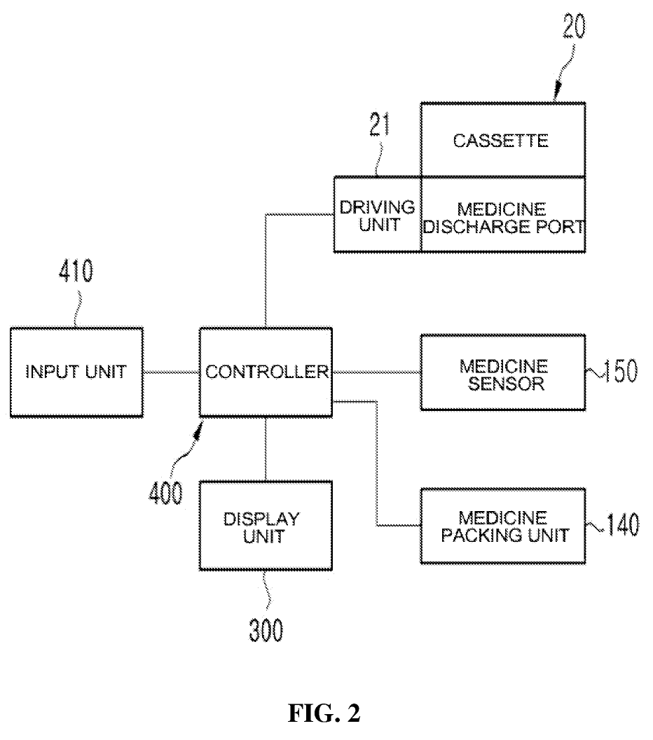

FIG. 1 is a front view illustrating an automatic medicine packing machine in accordance with the present invention and FIG. 2 is a block diagram schematically illustrating the automatic medicine packing machine in accordance with the present invention.

With reference to FIGS. 1 and 2, an automatic medicine packing machine in accordance with one embodiment of the present invention includes a main body 100, cassette supports 200, display units 300 and a controller 400.

First, an installation space 110, in which cassettes 20 are installed, is formed within the main body 100, and a hopper 120 into which medicines 10 are dropped is installed in the lower portion of the installation space 110.

Further, a lower case 130 provided with a medicine outlet formed on the front surface thereof may be further installed under the main body 100.

A medicine packing unit 140 which packs the medicines 10 discharged from the hopper 120 within medicine packets and discharges the medicine packets to the outside through the medicine outlet 131 may be further installed in the lower case 130.

The medicine packing unit 140 may be installed under the hopper 120, as exemplarily shown in FIG. 1, and continuously packs the medicines 10 discharged from the hopper 120 within the medicine packets and discharges the medicine packets to the outside through the medicine outlet 131.

For this purpose, a medicine packet supply unit (not shown) to supply medicine packets (not shown) may be installed in the lower case 130.

Further, a transparent window may be formed on the front surface of the main body 100 so that a worker may easily observe the installation space 110 from the outside.

In addition, medicine sensors 150, which sense a point of time of discharge of the medicines 10 and transmit a signal to the controller 400, which will be described later, may be installed in the hopper 120 of the main body 100.

The medicine sensors 150 sense a point of time of dropping of the medicines 10 into the hopper 120 and then transmit a drop sensing signal to the controller 400, which will be described later.

In addition, another medicine sensor 150, which senses a point of time of discharge of the medicine 10, may be installed at a medicine discharge port of the cassette 20.

The controller 400, which will be described later, may senses a medicine discharge time through the point of time of discharge of the medicine 10 through the medicine discharge port of the cassette 20 and the point of time of dropping of the medicine 10 into the hopper 120.

That is, the controller 400, which will be described later, may predetermine reference mounting positions according to characteristics of selected medicines 10 using the above-described medicine sensors 150.

The cassette supports 200 are installed in parallel in multiple stages in the vertical direction of the installation space 110, and a plurality of cassette mounting positions 210 of the cassettes 20 accommodating the medicines 10 are formed on the cassette support 200 in the horizontal direction.

The cassettes 20 are installed at the cassette mounting positions 210 of the cassette supports 200, and a medicine storage space is formed in the cassette 20.

Here, the medicine discharge port (not shown) to discharge the medicine 10 in the downward direction may be formed at the lower end of the cassette 20.

Further, a driving unit (not shown) operated under the control of the controller 400, which will be described later, to discharge the medicine 10 accommodated in the cassette 20 downwards may be installed in the cassette 20.

The driving unit may include a motor (not shown) driven by power supplied from the outside and a rotary body (not shown) rotated by rotating force of the motor.

For example, as the rotary body is rotated by driving force of the motor, a dose of the medicine 10 may be discharged to the hopper 120 through the medicine discharge port.

Such a cassette 20 may be mounted at the detected reference mounting position under the condition that the selected medicine 10 is put into the cassette 20.

The display unit 300 may be installed at the cassette mounting position 210 of the cassette support 20. The display unit 300 receives an operating signal transmitted from the outside and displays the cassette mounting position 210 to the outside.

Differently, the display unit 300 may be separately installed at the outer region of the main body 100, i.e., the display unit 300 may be installed at a part of the main body 100.

Such a display unit 300 may be provided as a lamp to output light to the outside or a speaker to output sound (voice, etc.) to the outside, thus indicating optimal reference mounting position out of the cassette mounting positions 210.

For example, if the display unit 300 is provided as a lamp, the lamp may be installed at each of the cassette mounting positions 210. That is, the reference mounting positions of the medicines 10 may be displayed to the outside by turning on the lamps.

Differently, if the display unit 300 is provided as a speaker (not shown), the reference mounting positions of the medicines 10 may be displayed to the outside by outputting sound (voice, etc.) through the speakers.

Here, identification numbers may be displayed at the cassette mounting positions 210 and the identification numbers of the cassette mounting positions 210 may be output through the speakers.

Of course, the lamps may be turned on to output light and simultaneously the speakers may output sound, thereby allowing a user to recognize the reference mounting positions.

The controller 400 may predetermine test information on the selected medicines 10 and optimal reference mounting positions according to the selected medicines 10.

The reference mounting position means the optimal position of the medicine 10 discharged from the cassette 20, and may include the closest height to a dropped point of the medicine 10 into the hopper 120.

The controller 400, if medicine information is input from the outside, displays the reference mounting positions of cassettes 20, which need to be mounted, according to the received medicine information.

Here, the controller 400 may operate the display units 300 to display the reference mounting positions of the cassettes 20 to the outside, thus recommending optimal mounting positions.

The reference mounting positions predetermined by the controller 400 may be predetermined in order of priority based on test information on the selected medicines 10.

That is, the controller 400 may detect the reference mounting positions, at which no cassettes 20 are installed, and then indicate the reference mounting position having the highest priority to the outside.

For example, if the medicine 10 is hard, a position having a height at which the medicine 10 does not bounce from the hopper 120 may serve as a reference mounting position.

On the other hand, if the medicine 10 is not hard, a position having a height at which the medicine 10 is not easily broken due to impact of colliding with the hopper 120 may serve as a reference mounting position.

The controller 400, if a medicine information input signal is transmitted from the outside (through a barcode recognition method, a near field communication method, etc.), may detect optimal positions of cassettes 20, to which the selected medicines 10 will be input, using the predetermined reference mounting positions of the medicines 10 and then indicate the detected optimal positions of the cassettes 20 to the outside.

A communication module (not shown) may be further installed in the above-described cassette 20, and the controller 400 may transmit an operating signal to the communication module of the cassette 20 to operate the driving unit 21 of the cassette 20.

Further, an input unit 410 to select kinds of the medicines 10 may be electrically connected to the controller 400.

The input unit 410 may display a list of the medicines 10 predetermined by the controller 400, and include a selection switch to select the medicines 10 and a power control switch (not shown) to control power of the automatic medicine packing machine.

An assistant display unit (not shown) to display various pieces of information on the medicines 10 to the outside may be installed in the input unit 410.

The controller 400 may predetermine information on error medicines having high error occurrence frequency, after inspection of medicine packets in which the medicines 10 are packed.

The controller 400 may detect the reference mounting positions of cassettes 20 according to the predetermined error medicines and then operate the display units 300 to indicate the reference mounting positions of cassettes 20, which will accommodate error medicines, to the outside.

Further, test results using types, ingredients, etc. of the medicines 10 may be re-input to the controller 400. In this case, the controller 400 may update the existing predetermined information with newly generated information on error medicines.

That is, information on error medicines may be easily updated so that reference mounting positions of various medicines may be proposed and, thus, error occurrence probability during the medicine packing process may be lowered.

Consequently, in the automatic medicine packing machine in accordance with the present invention, cassettes 20 accommodating selected medicines 10 may be mounted at reference mounting positions according to characteristics of the corresponding medicines 10 and, thus, release of the medicines 10 to the outside due to bouncing of the medicines 10 may be prevented and mixing of the medicines 10 or breakage of the medicines 10 during the packing process may be prevented, thereby optimizing a prescription filling speed.

Although the automatic medicine packing machine in accordance with the embodiment of the present invention has been described, those skilled in the art will appreciate that various modifications, additions and substitutions are possible, without departing from the scope and spirit of the invention as disclosed in the accompanying claims.

As apparent from the above description, an automatic medicine packing machine in accordance with the present invention recommends optimal discharge positions of medicines according to characteristics of the medicines and installs cassettes accommodating the medicines at the recommended optimal discharge positions so as to prevent the medicines dropping into a hopper from bouncing and thus being separated to the outside, and prevents mixing or breakage of the medicines so as to optimize a prescription filling speed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An automatic medicine packing machine comprising:
a main body provided with an installation space formed therein and a hopper formed in the lower portion thereof to allow medicines to be dropped into the hopper;
cassette supports installed in the installation space and having mounting positions of cassettes to accommodates the medicines;
display units configured to receive a driving signal transmitted from the outside and then to display the cassette mounting positions to the outside; and
a controller configured to predetermine information on selected medicines and reference mounting positions of the selected medicines and to, if medicine information is input from the outside, display positions of the cassettes to be mounted based on the input medicine information to the outside through the display units.

2. The automatic medicine packing machine according to claim 1, wherein the display units are respectively installed at the cassette mounting positions and output light or sound to the outside so as to indicate the cassette mounting positions to the outside.

3. The automatic medicine packing machine according to claim 1, wherein
a communication module is installed in the cassette; and
the controller transmits an operating signal to the communication module so as to operate the cassette.

4. The automatic medicine packing machine according to claim 1, wherein:
order of priority of the reference mounting positions is predetermined according to the information on the selected medicines; and
the controller detects the reference mounting positions having no cassettes installed there at and then indicates the reference mounting position having the highest priority to the outside.

5. The automatic medicine packing machine according to claim 1, wherein:
a lower case provided with an outlet formed on the front surface thereof is installed under the main body; and
a medicine packing unit installed under the hopper and serving to pack the medicines discharged from the hopper within medicine packets and to discharge the medicine packets to the outside through the outlet is provided in the lower case.

6. The automatic medicine packing machine according to claim 1, wherein the controller inspects medicine packets packing the medicines, predetermines information on error medicines having high error occurrence frequency, detects the reference mounting positions of the cassettes according to the predetermined error medicines, and indicates the reference mounting positions of the cassettes to be mounted based on the input medicine information to the outside through the display units.
